(19) United States
(12) Patent Application Publication
(10) Pub. No.: US 2010/0321278 A1
(43) Pub. Date: Dec. 23, 2010

(54) PANEL FOR A DISPLAY AND ELECTRONIC DEVICE USING SAME

(75) Inventors: CHWAN-HWA CHIANG, Shindian (TW); FENG-YUEN DAI, Shindian (TW); QI-JIAN DU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/716,342

(22) Filed: Mar. 3, 2010

(30) Foreign Application Priority Data
Jun. 18, 2009 (CN) 200910303423.X

(51) Int. Cl. G09G 3/20; B32B 15/00; B32B 9/00; B32B 5/00; B32B 27/00; B32B 27/32; B32B 27/34; B32B 27/36; B32B 17/00

(52) U.S. Cl. 345/55; 428/457; 428/698; 428/336; 428/335; 428/412; 428/523; 428/474.4; 428/480; 428/426

(57) ABSTRACT

A panel for a display comprises a transparent substrate, a first light transmission enhancing coating formed on one surface of the substrate, a second light transmission enhancing coating formed on the other surface of the substrate, and a metallic coating formed on the second light transmission enhancing coating. An electronic device using the panel is also provided.

### CROSS-REFERENCE TO RELATED APPLICATIONS

This application is related to co-pending U.S. patent application Ser. No. 12/647,641 (Attorney Docket No. US 25884), entitled “COVER FOR A DISPLAY SCREEN AND ELECTRONIC DEVICE BY HAVING SAME”. Such application has the same assignee as the present application and was filed on Dec. 28, 2009. The above-identified application is incorporated herein by reference.

### BACKGROUND

1. Technical Field

The present disclosure relates to a panel for a display, especially to a panel having a reflective appearance and an electronic device using the panel.

2. Description of Related Art

A panel for a display having a metallic appearance is often considered attractive. A common method of manufacturing the panel is application of a metal coating to a transparent substrate using vacuum deposition. When the panel is used for a display of electronic device, the metal coating applied to the transparent substrate should not block electromagnetic waves and should also have high light transmission property. However, sometimes, metal coatings can prevent too much light from passing through the panel.

Therefore, there is room for improvement within the art.

### BRIEF DESCRIPTION OF THE FIGURES

Many aspects of the panel for a display and an electronic device using such a panel can be better understood with reference to the following figures. The components in the figures are not necessarily drawn to scale, the emphasis instead being placed upon clearly illustrating the principles of the panel for a display and the electronic device. Moreover, in the drawings like reference numerals designate corresponding parts throughout the several views.

FIG. 1 is a cross-section of an exemplary embodiment of a panel for a display.

FIG. 2 is a schematic view of an exemplary embodiment of an electronic device using a panel such as, for example, that of FIG. 1.

### DETAILED DESCRIPTION

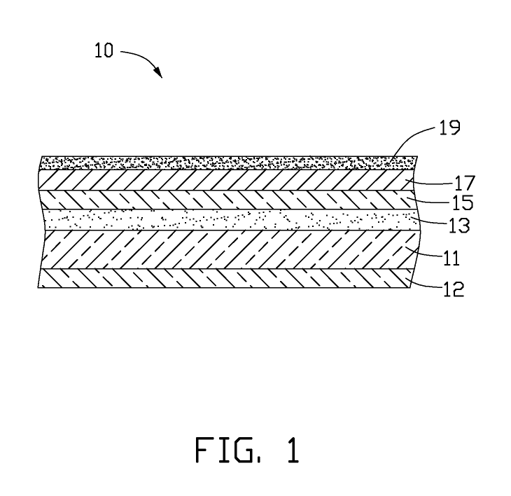

Referring to FIG. 1, in an exemplary embodiment, a panel 10 for a display includes a transparent substrate 11, a first light transmission enhancing coating 12 formed on one surface of the substrate 11, a base coating 13 formed on the other surface of the substrate 11, a second light transmission enhancing coating 15 formed on the base coating 13, a metallic coating 17 formed on the second light transmission enhancing coating 15, and a top coating 19 formed on the metallic coating 17. Light can pass through the metallic coating 17.

The transparent substrate 11 may be made of transparent plastic selected from a group consisting of polypropylene (PP), polyamide (PA), polycarbonate (PC), polymethyl methacrylate (PMMA), and polyethylene terephthalate (PET). Alternatively, the substrate 11 may be made of glass.

The first light transmission enhancing coating 12 may be a silicon dioxide film or a titanium dioxide film applied, for example, by vacuum evaporation deposition. The first light transmission enhancing coating 12 may have a thickness of about 80-200 nm. The silicon dioxide micro-articles or titanium dioxide micro-articles contained in the light transmission enhancing coating 12 act like a plurality of convex lenses and concentrate light such that the intensity of the light passed through the light transmission enhancing coating 12 is enhanced. The first light transmission enhancing coating 12 may also be a commix coating containing several low-refraction index layers and several high-refraction index layers stacked alternately for enhancing the light intensity passed through the light transmission enhancing coating 12. The low-refraction index material may be silicon dioxide or aluminum oxide. The high-refraction index material may be trititanium pentoxide (Ti₃O₅), zirconia (ZrO₂) or tantalum pentoxide (Ta₂O₅).

The base coating 13 may be a transparent ultraviolet (UV) curable paint coating or an acrylic resin paint coating. The base coating 13 may have a thickness of about 1-30 μm. The base coating 13 enhances the bonding between the substrate 11 and the second light transmission enhancing coating 15.

The second light transmission enhancing coating 15 can be the same as the first light transmission enhancing coating 12. The two light transmission enhancing coatings can enhance the light intensity passed through the two coatings for the reasons described above. As such the light intensity passed through the metallic coating 17 is enhanced.

The metallic coating 17 may be formed by vacuum evaporation deposition. The metallic coating 17 has a metallic appearance. The material used for the metallic coating 17 can be indium, tin, indium-tin alloy, aluminum, titanium, titanium carbide, stainless steel or aluminum-silicon alloys. The thickness of the metallic coating 17 is about 0.01-10 μm. The metallic coating 17 can be made nonconductive without blocking excessive radio signals by coating material selection and coating thickness control. When the panel 10 is fixed on an electronic device and the electronic device is not in use, no light is emitted from inside of the electronic device, and, the surface of the metallic coating 17 bonded with the top coating 19 is highly reflective (of about 20-75% reflectivity) of ambient light. When the electronic device is in use, the light emitted from inside of the electronic device passes through the metallic coating 17 (a high light transmissivity of about 15-65%) with the enhancing effect of the first and second light transmission enhancing coats.

The top coating 19 may be a transparent paint coating having a thickness of about 10-50 μm. The paint used for forming the top coating 19 may be UV curable paint, polyurethane paint, or unsaturated polyester paint. In this exemplary embodiment, UV curable paint is used. The top coating 19 may have high rigidity to protect the metallic coating 17 from abrasion. The paint used for the top coating 19 can be tinted for aesthetic reasons as long as it maintains its transparency.

The base coating 13 is applied as a bonding agent between the second light transmission enhancing coating 15 and the substrate 11 but may be omitted in applications that allow a bond to be formed by applying the second light transmission enhancing coating 15 directly on the substrate 11.

The top coating 19 may be omitted in applications where abrasion of the panel for a display is not a concern.

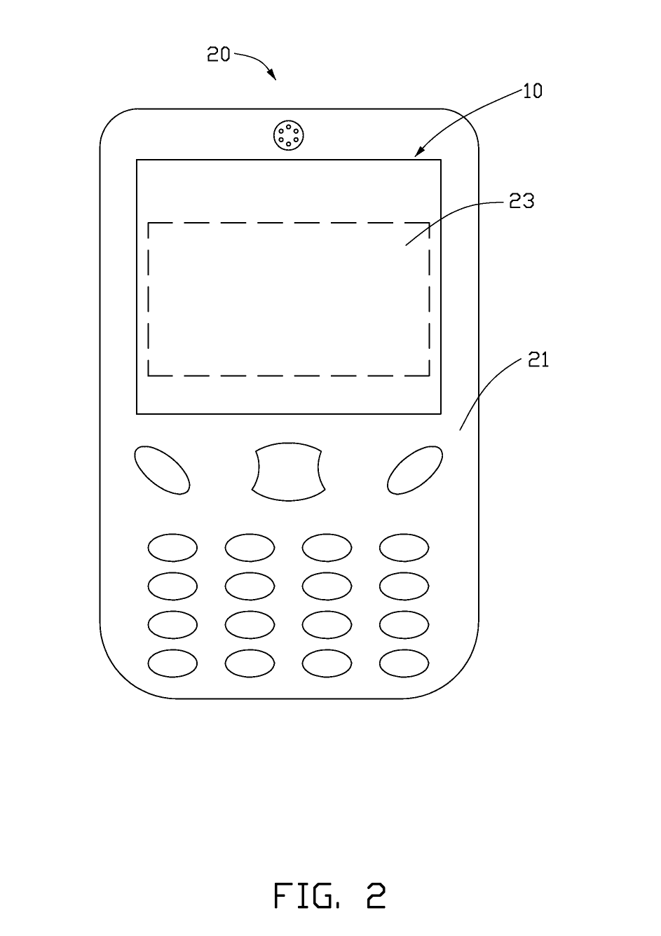

FIG. 2 shows an electronic device 20 including a main body 21 and a panel 10 for a display. The main body 21 includes a display 23 and the panel 10 positioned over the display 23. The panel 10 includes a transparent substrate 11, a first light transmission enhancing coating 12 formed on one surface of the substrate 11, a base coating 13 formed on the other surface of the substrate 11, a second light transmission enhancing coating 15 formed on the base coating 13, a metallic coating 17 formed on the second light transmission enhancing coating 15, and a top coating 19 formed on the metallic coating 17. The first light transmission enhancing coating 12 faces the display 23 when the panel 10 is positioned over the display 23. Light emitted by the display 23 of the main body 20 passes through the first light transmission enhancing coating 12, the substrate 11, the base coating 13, and the second light transmission enhancing coating 15, and with the enhancing effect of the first and second light transmission enhancing coatings, the light can further pass through the metallic coating 17 and the top coating 19. When the electronic device 20 is not in use, the surface of the metallic coating 17 bonded with the top coating 19 is highly reflective of ambient light.

The exemplary electronic device 20 may be a mobile phone, a PDA, a MP3 or a MP4.

It should be understood, however, that though numerous characteristics and advantages of the present embodiments have been set forth in the foregoing description, together with details of functions of the embodiments, the disclosure is illustrative only, and changes may be made in detail within the principles of the disclosure to the full extent indicated by the broad general meaning of the terms in which the appended claims are expressed.

What is claimed is:

1. A panel for a display, comprising:
a transparent substrate;
a first light transmission enhancing coating formed on one surface of the substrate;
a second light transmission enhancing coating formed on the other surface of the substrate; and
a metallic coating formed on the second light transmission enhancing coating.

2. The panel as claimed in claim 1, wherein the first and the second light transmission enhancing coatings are silicon dioxide films or titanium dioxide films having a thickness of about 80-200 nm.

3. The panel as claimed in claim 1, wherein the metallic coating is indium, tin, indium-tin alloy, aluminum, titanium, titanium carbide, stainless steel, or aluminum-silicon alloy formed by vacuum evaporation deposition.

4. The panel as claimed in claim 3, wherein the metallic coating has a thickness of about 0.01-10 μm.

5. The panel as claimed in claim 1, further including a base coating formed between the substrate and the second light transmission enhancing coating.

6. The panel as claimed in claim 5, wherein the base coating is a transparent ultraviolet curable paint coating or an acrylic resin paint coating having a thickness of about 1-30 μm.

7. The panel as claimed in claim 1, further including a top coating formed on the metallic coating, the top coating is a transparent ultraviolet curable paint coating having a thickness of about 10-50 μm.

8. The panel as claimed in claim 1, wherein the substrate is made of transparent plastic selected from a group consisting of polypropylene, polyamide, polycarbonate, polymethyl methacrylate, and polyethylene terephthalate.

9. The panel as claimed in claim 1, wherein the substrate is made of glass.

10. An electronic device, comprising:
a main body comprising a display; and
a panel positioned over the display;
wherein the panel includes a transparent substrate, a first light transmission enhancing coating formed on one surface of the substrate, a second light transmission enhancing coating formed on the other surface of the substrate, and a metallic coating formed on the second light transmission enhancing coating; wherein light emitted by the display passes through the first light transmission enhancing coating, the transparent substrate, the second light transmission enhancing coating and the metallic coating.

11. The electronic device as claimed in claim 10, wherein the first and the second light transmission enhancing coatings are silicon dioxide film or titanium dioxide film having a thickness of about 80-200 nm.

12. The electronic device as claimed in claim 10, wherein the metallic coating is indium, tin, indium-tin alloy, aluminum, titanium, titanium carbide, stainless steel, or aluminum-silicon alloy formed by vacuum evaporation deposition.

13. The electronic device as claimed in claim 12, wherein the metallic coating has a thickness of about 0.01-10 μm.

14. The electronic device as claimed in claim 10, wherein the panel further includes a base coating formed between the substrate and the second light transmission enhancing coating.

15. The electronic device as claimed in claim 14, wherein the base coating is a transparent ultraviolet curable paint coating or an acrylic resin paint coating having a thickness of about 1-30 μm.

16. The electronic device as claimed in claim 10, wherein the panel further includes a top coating formed on the metallic coating, the top coating is a transparent ultraviolet curable paint coating having a thickness of about 10-50 μm.

17. The electronic device as claimed in claim 10, wherein the substrate is made of transparent plastic selected from a group consisting of polypropylene, polyamide, polycarbonate, polymethyl methacrylate, and polyethylene terephthalate.

18. The electronic device as claimed in claim 10, wherein the substrate of the panel is made of glass.
